(19) United States
(12) Patent Application Publication
(10) Pub. No.: US 2026/0058813 A1
(43) Pub. Date: Feb. 26, 2026

(54) SECURE INTEGRATION OF ACQUIRED DATA SOURCES IN A MULTITENANT ENVIRONMENT

(71) Applicant: WORKDAY, INC., Pleasanton, CA (US)

(72) Inventor: Nuno MOREIRA, Dublin (IE)

(21) Appl. No.: 18/813,243

(22) Filed: Aug. 23, 2024

(51) Int. Cl. H04L 9/32

(52) U.S. Cl. CPC H04L 9/3213

(57) ABSTRACT

A disclosed method may include authorizing, by a processor, via an extension platform of a target multitenant platform, an acquisition entity to integrate acquisition entity data hosted by a source cloud platform into a target shared data resource of the target multitenant platform. The disclosed method may further include integrating, by the processor, in response to the authorization, acquisition entity data with the target shared data resource of the target multitenant platform, and validating, by the processor, the integrated acquisition entity data by (1) generating an input vector based on the acquisition entity data, and (2) inputting the input vector into a predictive model, the predictive model generating, based on the input vector, an output indicating potential data discrepancies in the integrated acquisition entity data. Various other methods, systems, and computer-readable media are also disclosed.

### BACKGROUND

In conventional systems of data integration and management, there are often issues in dealing with the secure transfer and integration of data from third-party or acquired systems into a target multitenant platform. Manual intervention is frequently required in managing application programming interface (API) keys and tokens, which may increase the risk of data exposure and security breaches. Additionally, the traditional process of integrating and synchronizing data between different systems often involves significant time, cost, and implementation effort. It is also common for the conventional systems to struggle with data validation, especially when the data models are complex, and the data is pulled from different sources. Errors may not be surfaced in a user-friendly or easily understandable way, making it difficult for users to address them. Furthermore, these conventional systems often lack the ability to learn from past errors and suggest fixes for new occurrences, leading to a repetitive and inefficient error resolution process. Lastly, the detection and reconciliation of potential duplicate entries is a common challenge, as it requires a robust mechanism to identify similar entities across different systems and suggest appropriate actions.

### BRIEF DESCRIPTION OF THE FIGURES

FIG. 1 is a block diagram of an example system for secure integration of acquired data sources in a multitenant environment.

FIG. 2 is a block diagram of an example implementation of a system for secure integration of acquired data sources in a multitenant environment.

FIG. 3 is a flow diagram of an example method for secure integration of acquired data sources in a multitenant environment.

FIG. 4A, FIG. 4B, and FIG. 4C are block diagrams of an example implementation of a system for secure integration of acquired data sources in a multitenant environment according to some of the disclosed embodiments.

FIG. 5 is an operational flow diagram that illustrates an operational flow of an example system for secure integration of acquired data sources in a multitenant environment according to some of the disclosed embodiments.

FIG. 6 is a block diagram illustrating an artificial-intelligence-augmented (AI-augmented) data integration system according to some of the disclosed embodiments.

FIG. 7 and FIG. 8 illustrate interactive user interfaces for an AI-augmented data integration system, designed to facilitate a range of data integration operations within an example organization's environment.

FIG. 9 is a block diagram of a computing device according to some embodiments of the disclosure.

### DETAILED DESCRIPTION

The present disclosure is generally directed to systems and methods for secure integration of acquired data sources in a multitenant environment. The present disclosure may generally set forth a comprehensive framework for the secure integration and management of data within a multitenant platform, facilitated by an advanced extension platform that orchestrates the efficient and secure transfer of data from various acquired systems into a target shared data resource. Some disclosed embodiments include a suite of modules and services that may synergistically address the challenges associated with traditional data integration methods.

Within the scope of these embodiments, an authorization module incorporated within the extension platform may enable a target multitenant platform to grant permissions to acquisition entities for data integration, circumventing the manual management of API keys and tokens and thereby bolstering the security mechanisms in place for data transfer. In addition, some disclosed embodiments may utilize a machine learning-based predictive model for validating and identifying potential data inconsistencies. This predictive model may be designed not only to refine its accuracy with each data synchronization event but also to enhance the computational efficiency of the computer system by optimizing error detection and correction workflows.

The self-service functionalities introduced by some embodiments of the present disclosure may substantially alleviate a burden of implementation, reducing both time and financial investment typically required. These functionalities may be manifested through a user interface that enables straightforward data correction and provides mass fix options, along with intelligent error resolution suggestions drawn from a corpus of historical data. The impact of these features extends beyond the improvement of the computer system itself; they also advance the field of data management and integration by dramatically decreasing the necessity for manual oversight, expediting the process of data synchronization, and offering users a more intuitive and user-friendly interaction with the system.

In some implementations, the disclosure relates to a method including: authorizing, by a processor, via an extension platform of a target multitenant platform, an acquisition entity to integrate acquisition entity data hosted by a source cloud platform into a target shared data resource of the target multitenant platform; integrating, by the processor, in response to the authorization, acquisition entity data with the target shared data resource of the target multitenant platform; validating, by the processor, the integrated acquisition entity data by: generating an input vector based on the acquisition entity data; and generating an output indicating potential data discrepancies in the integrated acquisition entity data by inputting the input vector into a predictive model; responding, by the processor, to the output indicating potential data discrepancies by: suggesting resolutions for a subset of the potential data discrepancies based on historical data; generating a user interface displaying the potential data discrepancies and suggested resolutions; and enabling a user to resolve the potential data discrepancies through the user interface; and applying at least one of the suggested resolutions across multiple data entries.

In some implementations, the disclosure relates to a method, further including: receiving, by the processor, a request to map a target tenant of the target multitenant platform to an acquisition instance of the source cloud platform corresponding to the acquisition entity; and mapping, by the processor, via an internal authentication service of the target multitenant platform, the acquisition instance of the source cloud platform to the target tenant in the target multitenant platform.

In some implementations, the disclosure relates to a method, further including: configuring, by the processor via the internal authentication service of the target multitenant platform, a tenant mapping information endpoint within the source cloud platform that, when queried with information associated with the acquisition entity, returns identifying information of the target tenant; receiving, by the processor via the tenant mapping information endpoint, a query including information associated with the acquisition entity; and returning, by the processor via the tenant mapping information endpoint in response to the query, identifying information of the target tenant.

In some implementations, the disclosure relates to a method, further including authorizing, by the processor via the extension platform of the target multitenant platform, the source cloud platform to transfer data associated with the acquisition entity and hosted by the source cloud platform by: receiving a request to send, via the source cloud platform, a credential to the acquisition entity; and sending, to the acquisition entity via the source cloud platform, the credential.

In some implementations, the disclosure relates to a method, further including authorizing, by the processor via the extension platform of the target multitenant platform, the source cloud platform to transfer data associated with the acquisition entity and hosted by the source cloud platform by: receiving, via an authorization service of the extension platform of the target multitenant platform, a request from the acquisition entity for an authorization token, the request including the credential; generating, via the authorization service of the extension platform of the target multitenant platform, an authorization token; and sending, via the source cloud platform, the authorization token to the acquisition entity.

In some implementations, the disclosure relates to a method, further including: receiving, by the processor via an application programming interface (API) endpoint hosted by the extension platform of the target multitenant platform, a data integration request including the authorization token; authenticating, by the processor, the authorization token; and authorizing, by the processor, the acquisition entity to integrate acquisition entity data hosted by the source cloud platform into the target shared data resource of the target multitenant platform in response to authenticating the authorization token.

In some implementations, the disclosure relates to a method, further including allocating, by the processor, resources within the target multitenant platform to a target tenant in response to a tenant setup request received from the acquisition entity via the source cloud platform.

In some implementations, the disclosure relates to a method, further including integrating, by the processor, acquisition entity data with the target shared data resource of the target multitenant platform by transferring encrypted data associated with the acquisition entity to the multitenant data resource of the target multitenant platform.

In some implementations, the disclosure relates to a method, further including decrypting, by the processor, the encrypted data associated with the acquisition entity via a decryption service of the extension platform of the target multitenant platform.

In some implementations, the disclosure relates to a method, further including providing, by the processor, a self-service task to the acquisition entity to enable integration of the acquisition entity data with the target shared data resource.

In some implementations, the disclosure relates to a method, further including storing, by the processor, generated credentials associated with the acquisition entity in a secure credential store accessible only during runtime and isolated from users, the generated credentials used for authentication during the integration of acquisition entity data with the target shared data resource of the target multitenant platform.

In some implementations, the disclosure relates to a method, further including training, by the processor, the predictive model using historical data and known data discrepancies to improve accuracy in detecting potential data discrepancies in future integrated data.

In some implementations, the disclosure relates to a method, further including utilizing, by the processor, a feedback mechanism, where corrected data discrepancies are used as new training data for the predictive model.

In some implementations, the disclosure relates to a method, further including validating, by the processor, the output of the predictive model against known outcomes to improve a performance metric of the predictive model over time.

In some implementations, the disclosure relates to a method, further including employing a plurality of different machine learning algorithms in the predictive model to optimize detection of potential data discrepancies.

In some implementations, the disclosure relates to a method including: collecting, by a processor, a data set associated with a set of integrated acquisition entities of a target multitenant platform, the data set including, for each integrated acquisition entity included in the set of integrated acquisition entities, integrated acquisition entity data associated with the acquisition entity; training, based on the data set, a predictive model to generate, based on an input vector, an output indicating potential data discrepancies in the integrated acquisition entity data, the training including: cleaning the data set; transforming the data set into a format analyzable by the predictive model; analyzing the data set in accordance with a training methodology of the predictive model; and configuring the predictive model by adjusting one or more parameters included in the predictive model to improve accuracy in detecting potential data discrepancies in future integrated data.

In some implementations, the disclosure relates to a method, further including collecting, by the processor, the data set from a shared data resource of the target multitenant platform.

In some implementations, the disclosure relates to a method, further including tuning, by the processor, the predictive model by adjusting a hyperparameter of the predictive model, the hyperparameter selected from a set of hyperparameters including: a maximum depth of layers of the predictive model; and a maximum number of features of the predictive model.

In some implementations, the disclosure relates to a method including: receiving, by a processor, a query including data that describes integrated acquisition data of an acquisition entity; querying, by the processor, using the query, a plurality of predictive models to generate a plurality of outputs, each predictive model in the plurality of predictive models trained using a different data set associated with integrated acquisition entities of a target multitenant platform; aggregating, by the processor, the plurality of outputs into an aggregated output; and determining, by the processor, based on the aggregated output, potential data discrepancies in the integrated acquisition entity data by consolidating the plurality of outputs into a consolidated query result.

In some implementations, the disclosure relates to a method, further including generating, by the processor, a confidence score for the aggregated output, the confidence score indicating a likelihood that the aggregated output accurately identifies potential data discrepancies in the integrated acquisition entity data.

While the disclosure will be described with reference to various embodiments, it will be understood that these embodiments are not intended to limit the scope of the disclosure. On the contrary, the disclosure is intended to cover alternatives, modifications, and equivalents, which may be included within the spirit and scope of the disclosure as defined by the appended claims. The following detailed description, therefore, is not to be taken in a limiting sense, and the scope of the present disclosure is defined by the appended claims and their equivalents.

Various operations are described as multiple discrete steps to aid in understanding the disclosure. However, the order of description should not imply that these operations are necessarily dependent on sequence. In particular, these operations need not be performed in the order presented.

The present disclosure will now be described more fully hereinafter with reference to the accompanying figures, in which embodiments of the disclosure are shown. The disclosed subject matter may, however, be embodied in many different forms and should not be construed as limited to the embodiments set forth herein. Rather, these embodiments are provided so that this disclosure will be thorough and complete, and will fully convey the scope of the disclosed subject matter to those skilled in the art.

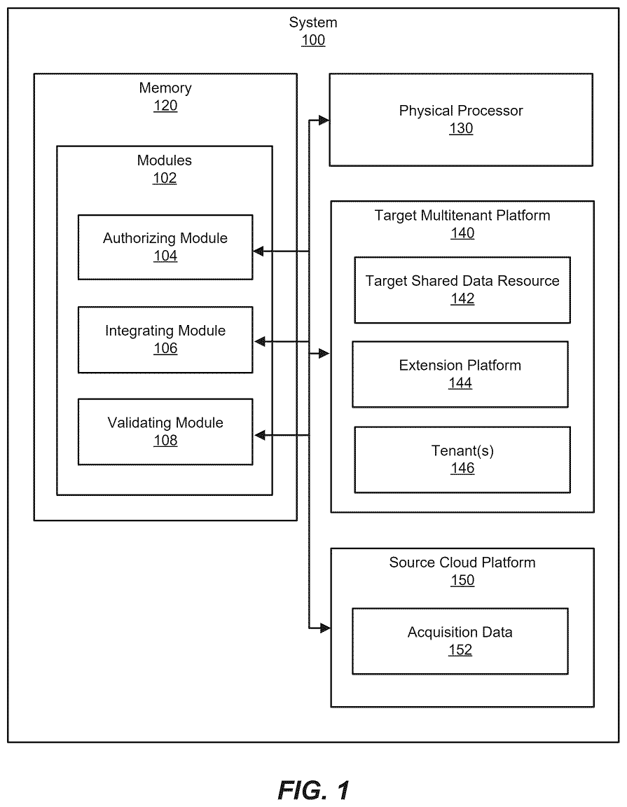

FIG. 1 is a block diagram of an example system 100 for secure integration of acquired data sources in a multitenant environment. As illustrated in this figure, example system 100 may include one or more modules 102 for performing one or more tasks. As will be explained in greater detail below, modules 102 may include an authorizing module 104 that may authorize, via an extension platform of a target multitenant platform, an acquisition entity to integrate acquisition entity data hosted by a source cloud platform into a target shared data resource of the target multitenant platform. Additionally, example system 100 may also include an integrating module 106 that may, in response to the authorization, integrate acquisition entity data with the target shared data resource of the target multitenant platform. Furthermore, example system 100 may also include a validating module 108 that may validate the integrated acquisition entity data. As will be described in greater detail below, validating module 108 may validate the integrated acquisition data by generating an input vector based on the acquisition entity data and inputting the input vector into a predictive model. The predictive model may generate, based on the input vector, an output indicating potential data discrepancies in the integrated acquisition entity data.

As further illustrated in FIG. 1, example system 100 may also include one or more memory devices, such as memory 120. Memory 120 generally represents any type or form of volatile or non-volatile storage device or medium capable of storing data and/or computer-readable instructions. In one example, memory 120 may store, load, and/or maintain one or more of modules 102. Examples of memory 120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As also illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 120. Additionally or alternatively, physical processor 130 may execute one or more of modules 102 to facilitate secure integration of acquired data sources in a multitenant environment. Examples of physical processor 130 include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As further illustrated in FIG. 1, example system 100 may also include a target multitenant platform 140. Target multitenant platform 140 may include a cloud-based environment designed to serve multiple tenants-organizations, businesses, or individual users-through a single instance of software running on a server. This platform may allow each tenant to operate as if they have their own dedicated instance of the software, despite all tenants being serviced by a shared infrastructure and code base.

One of the main features of target multitenant platform 140 may be scalability, enabling it to dynamically allocate resources as the number of tenants grows or as their usage increases, without compromising on performance or security. Data isolation is another critical attribute; the platform ensures each tenant's data is kept private and secure through logical separation techniques. While the core functionality is consistent across all tenants, the platform offers customization options, allowing tenants to tailor aspects of the software to meet their unique business needs.

Maintenance and upgrades are handled by the service provider, ensuring all tenants benefit from regular updates and new features without the need for individual maintenance efforts. An extension platform within the target multitenant platform further allows for the development and integration of additional applications or services, thus extending the core system's capabilities.

The shared infrastructure underlying the target multitenant platform optimizes resource usage, leading to cost efficiencies and a reduced environmental impact. Security and compliance are paramount, with the platform incorporating stringent security measures, including data encryption and secure access controls, while also adhering to industry standards and regulations.

Performance monitoring tools are an integral part of the platform, providing tenants with insights into their usage and system performance, ensuring that service level agreements are met. The platform's built-in disaster recovery capabilities, including data backups and failover mechanisms, assure tenants of business continuity.

The cloud-based nature of target multitenant platform 140 allows for global accessibility, giving tenants the flexibility to access the platform's services from any location with internet connectivity.

Target shared data resource 142 within the target multitenant platform 140 serves as a central repository for all data that is used and generated by the tenants. It provides a unified storage solution where data from different tenants is collected, processed, and made available. The data resource ensures that while data is centrally located, it is logically partitioned so that each tenant's data remains isolated and secure. This design allows for efficient data management, analysis, and retrieval, while also facilitating shared services among tenants when appropriate, all without compromising individual data privacy or integrity.

Extension platform 144, included in target multitenant platform 140, enables tenants to extend and customize the core functionalities of target multitenant platform 140 to better suit their individual business requirements. It may provide a suite of development tools, APIs, and services that allow for the creation of custom applications, integrations, and workflows. This flexibility empowers tenants to innovate and adapt the platform according to their evolving needs, while maintaining the benefits of the underlying cloud infrastructure. The extension platform is designed with security in mind, ensuring that any extensions or customizations adhere to the same rigorous security standards as the core platform.

As further shown in FIG. 1, tenant(s) 146 may include or represent resources of the individual customers or users who utilize target multitenant platform 140 for their operational needs. Each tenant operates within a secure, isolated environment that appears as a dedicated instance of the software, despite the underlying shared infrastructure. Tenants can range from small businesses to large enterprises, each with their own set of users, configurations, and data. They benefit from the scalability, reliability, and security of the multitenant platform while retaining the ability to customize and manage their own environment. The platform's architecture supports multiple tenants without sacrificing performance, enabling each tenant to operate independently and securely within the shared ecosystem.

As also shown in FIG. 1, example system 100 may also include a source cloud platform 150. Source cloud platform 150 is a computing platform that is based in the cloud. This platform hosts the data of an acquisition entity, referred to as acquisition entity data 152. The source cloud platform acts as a source from which this data is retrieved for integration into a target multitenant platform.

In some examples, source cloud platform 150 may include instances that correspond to different acquisition entities, each instance representing a specific company or entity that has been acquired (e.g., by an entity having authority and/or control over both target multitenant platform 140 and source cloud platform 150). These instances may carry unique identifiers and/or hold the respective acquisition data for each entity.

As will be described in additional detail below, in some examples, source cloud platform 150 may also include and/or feature an API endpoint, which may serve as a communication point for transmitting data between the source cloud platform and other components of the system, such as the target multitenant platform. The API endpoint may facilitate the exchange of data and commands, enabling the integration and synchronization of acquisition data with the shared data resource of the target multitenant platform.

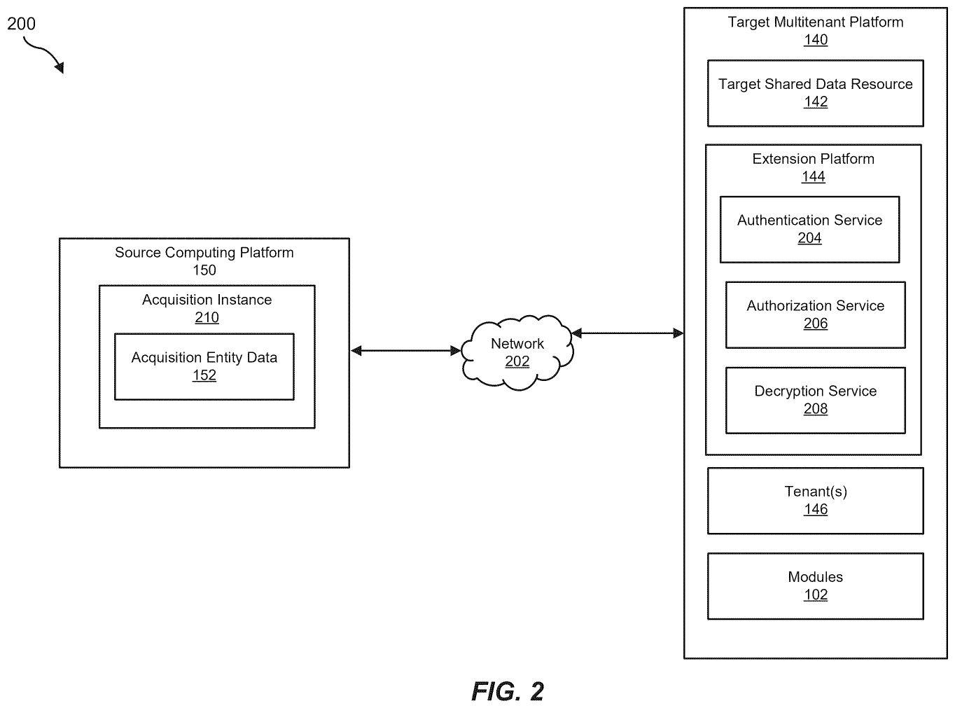

Example system 100 in FIG. 1 may be implemented in a variety of ways. For example, all or a portion of example system 100 may represent portions of an example system 200 (“example system 200”) in FIG. 2. As shown in FIG. 2, example system 200 may include target multitenant platform 140 in communication with source cloud platform 150 via network 202. In at least one example, target multitenant platform 140 may be programmed with one or more of modules 102. Additionally or alternatively, although not shown in FIG. 2, source cloud platform 150 may be programmed with one or more of modules 102.

In at least one embodiment, one or more modules 102 from FIG. 1 may, when executed by target multitenant platform 140 and/or source cloud platform 150, enable target multitenant platform 140 and/or source cloud platform 150 to perform one or more operations to enable secure integration of acquired data sources in a multitenant environment.

Network 202 generally represents any medium or architecture capable of facilitating communication and/or data transfer between target multitenant platform 140 and/or source cloud platform 150. Examples of network 202 include, without limitation, an intranet, a WAN, a LAN, a Personal Area Network (PAN), the Internet, Power Line Communications (PLC), a cellular network (e.g., a Global System for Mobile Communications (GSM) network, a code-division multiple access (CDMA) network, a Long-Term Evolution (LTE) network, a fifth-generation (5G) network, etc.), universal serial bus (USB) connections, and the like. Network 202 may facilitate communication or data transfer using wireless or wired connections. In one embodiment, network 202 may facilitate communication between target multitenant platform 140 and source cloud platform 150.

As shown in FIG. 2, in some examples, target multitenant platform 140 and/or target shared data resource 142 may include or host an authentication service 204, an authorization service 206, and/or a decryption service 208. Authentication service 204 may generally be responsible for verifying the identity of entities attempting to connect to the target multitenant platform. It utilizes a variety of mechanisms such as tokens, passwords, or digital certificates to confirm the identity of the entity. This service plays a critical role in ensuring that only authorized entities can access the target multitenant platform, thus maintaining the security and integrity of the data within the platform.

Authorization service 206 may complement the authentication service 204 by determining what level of access an authenticated entity should have. It defines and manages the roles, permissions, and privileges associated with each entity. For instance, it may grant certain entities the ability to read data, while others might have the ability to both read and write data. This service is fundamental in managing the access control policies within the target multitenant platform, ensuring that entities can only access the data and functions they are permitted to use.

Furthermore, decryption service 208 may be responsible for converting encrypted data, transferred into target multitenant platform 140, into a readable format. As data is often encrypted during transmission for security purposes, this service is essential for allowing the target multitenant platform to understand and process the received data. Decryption service 208 may use specific algorithms and keys to decipher the encrypted data, returning it to its original unencrypted state. This service is crucial for maintaining data privacy and security in the target multitenant platform, as it ensures that even if data is intercepted during transmission, it cannot be understood without the correct decryption keys.

Many other devices or subsystems may be connected to example system 100 in FIG. 1 and/or example system 200 in FIG. 2. Conversely, all of the components and devices illustrated in FIGS. 1 and 2 need not be present to practice the embodiments described and/or illustrated herein. The devices and subsystems referenced above may also be interconnected in different ways from those shown in FIG. 2. Example system 100 and/or example system 200 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

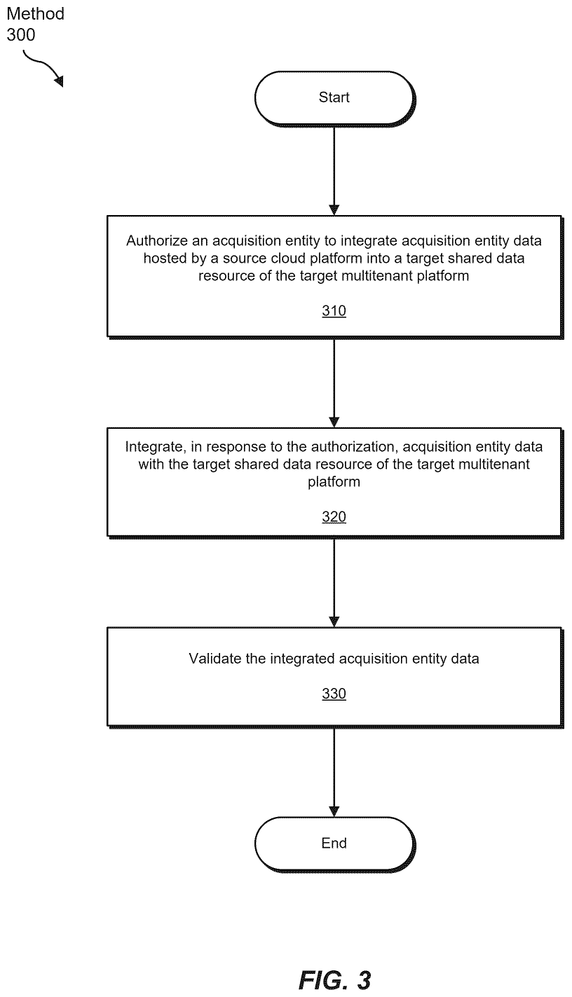

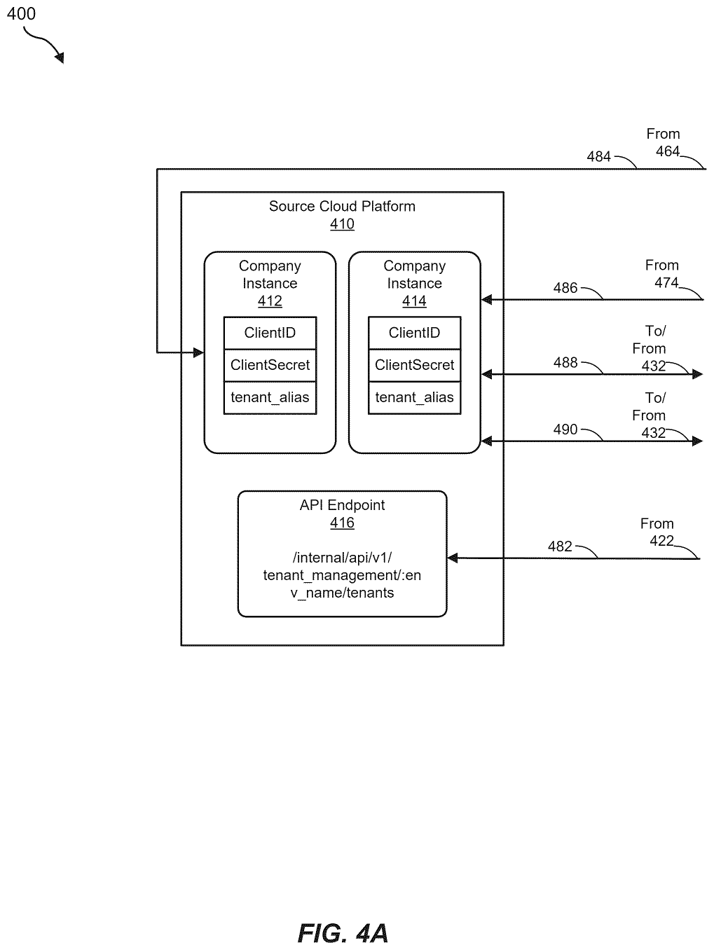

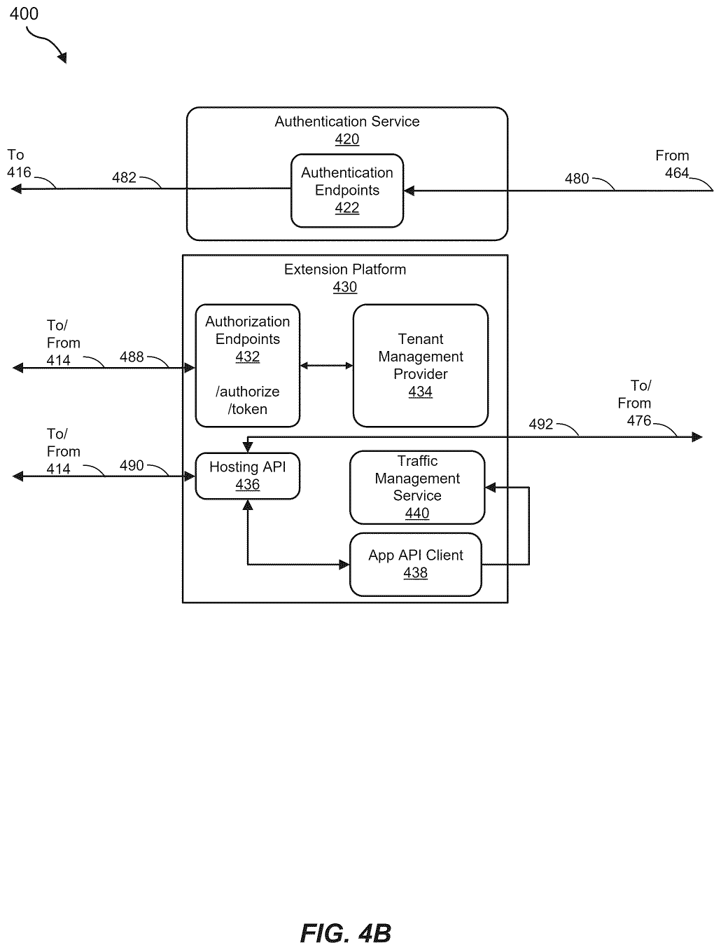

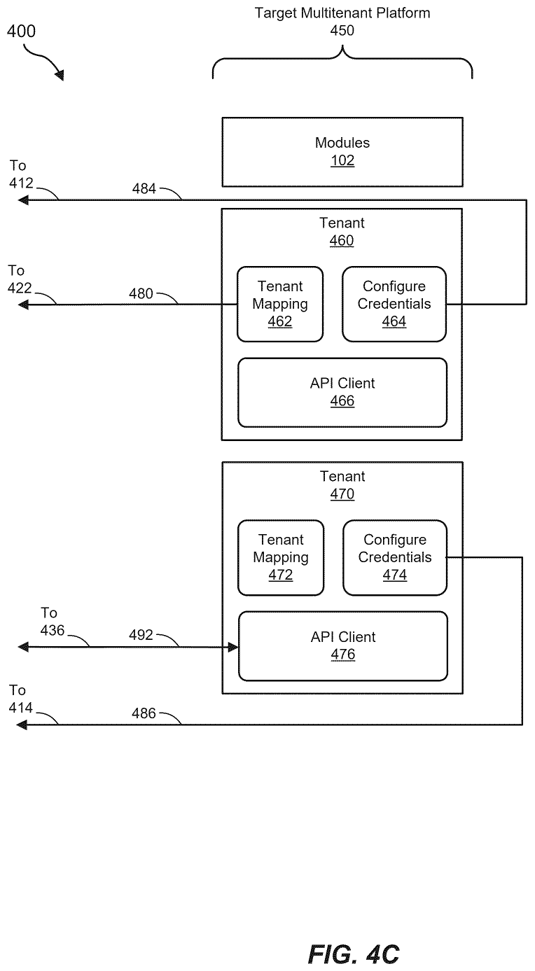

FIG. 3 is a flow diagram of an example computer-implemented method 300 for secure integration of acquired data sources in a multitenant environment. The steps shown in FIG. 3 may be performed by any suitable computer-executable code and/or computing system, including example system 100 in FIG. 1, example system 200 in FIG. 2, and/or variations or combinations of one or more of the same (e.g., example system 400 in FIG. 4A, FIG. 4B, and FIG. 4C, described below). In one example, each of the steps shown in FIG. 3 may represent an algorithm whose structure includes and/or is represented by multiple sub-steps, examples of which will be provided in greater detail below.

As illustrated in FIG. 3, at step 310, one or more of the systems described herein may authorize, via an extension platform of a target multitenant platform, an acquisition entity to integrate acquisition entity data hosted by a source cloud platform into a target shared data resource of the target multitenant platform. For example, authorizing module 104 may, as part of target multitenant platform 140, extension platform 144, or source cloud platform 150, cause target multitenant platform 140, extension platform 144, and/or source cloud platform 150 to authorize, via extension platform 144, an acquisition entity to integrate acquisition entity data 152 hosted by source cloud platform 150 into target shared data resource 142. As will be described in greater detail below in reference to FIG. 4A, FIG. 4B, and FIG. 4C, authorizing module 104 may interact with authentication service 204 and authorization service 206 within the extension platform 144 to verify the identity of the acquisition entity and grant the necessary permissions for data integration.

At step 320, one or more of the systems described herein may integrate, in response to the authorization, acquisition entity data with the target shared data resource of the target multitenant platform. For example, integrating module 106 may, as part of target multitenant platform 140, extension platform 144, or source cloud platform 150, cause target multitenant platform 140, extension platform 144, and/or source cloud platform 150 to integrate, in response to the authorization, acquisition entity data 152 with target shared data resource 142 target multitenant platform 140. Integrating module 106 may manage data transfer from source cloud platform 150, across the network 202, to target multitenant platform 140. If the data arrives encrypted, integrating module 106 may also coordinate with decryption service 208 to ensure the data is decrypted and in a usable format for integration with target shared data resource 142.

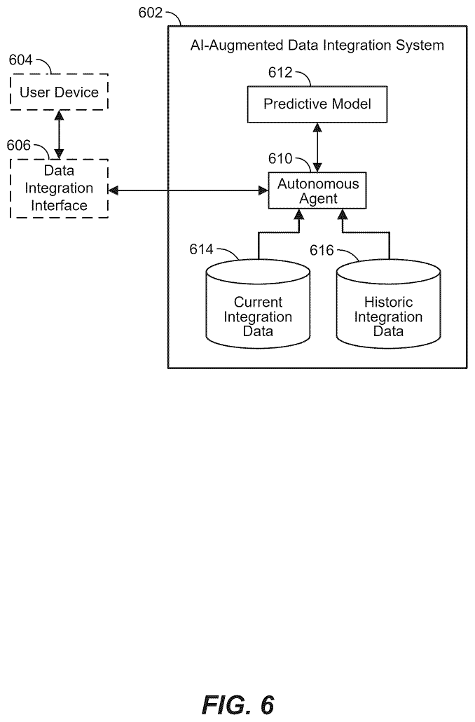

Continuing to step 330, one or more of the systems described herein may validate the integrated acquisition entity data. For example, validating module 108 may, as part of target multitenant platform 140, extension platform 144, or source cloud platform 150, cause target multitenant platform 140, extension platform 144, and/or source cloud platform 150 to validate acquisition entity data 152. In some examples, as will be described in greater detail below in reference to FIG. 6, validating module 108 may generate an input vector from the acquisition entity data and input this vector into a predictive model. The predictive model, based on the input vector, may produce an output that indicates potential data discrepancies in the integrated acquisition entity data. Hence, validating module 108 may ensure integrity and accuracy of the data integrated into the target multitenant platform.

FIG. 4A, FIG. 4B, and FIG. 4C collectively illustrate a detailed representation of a system architecture for secure data integration in a multitenant cloud environment. This architecture, labeled collectively as example system 400, delineates the flow of data and interactions between different components such as target multitenant platform 140, extension platform 144, and source cloud platform 150. These figures provide a comprehensive overview of the data mapping, authentication, and authorization processes involved in integrating acquired data from source systems to the target platform. The figures also provide insights into the services and operations involved in the token generation and validation, as well as data synchronization between different tenants in the multitenant platform.

FIG. 4A shows a source cloud platform 410, which may be an implementation or example of source cloud platform 150. Source cloud platform 410 contains two instances, each representing a different acquired company's data: Company instance 412 that hosts data for acquired Company A, and company instance 414 that hosts data for acquired Company B. Each of these instances includes a set of credentials needed for authentication and authorization within the system, the credentials are represented by three components: clientid, clientsecret, and tenant_alias. The clientid and clientsecret are unique identifiers used for authenticating the respective company's instance within the system. The tenant_alias is an additional identifier that represents the specific tenant within the target multitenant platform that may be associated with the respective company's instance.

Furthermore, the source cloud platform 410 also includes an API endpoint 416. This endpoint may provide a communication gateway for the source cloud platform 410 to interact with other components of the system. The path of this API Endpoint is specified as “/internal/api/v1/tenant_management/env_name/tenants”. This path indicates that the API endpoint 416 may be used for managing the mapping of tenants within a target multitenant environment (e.g., target multitenant platform 450).

FIG. 4B illustrates a segment of example system 400 focusing on extension platform 430 and authentication service 420. These components may aid in managing authentication and authorization processes, and may provide helpful functionality to enable data integration within a multitenant cloud environment.

Authentication service 420 includes authentication endpoints 422, which may provide features related to secure authentication of instances from source cloud platform 410. Authentication service 420 generally supports secure identity validation for a broad user base, including desktop and mobile users, as well as systems such as acquisition and integration systems. It operates as an independent service, tasked with identity verification based on customer-defined policies and managing sessions for users and systems. Built to be distributed, fault-tolerant, resilient, and highly available, it processes billions of transactions, thus scaling core business systems of target multitenant platform 450 while maintaining security.

Within system 400, authentication service 420 generates and validates authentication tokens, using credentials such as clientid and clientsecret to issue authorization tokens to acquisition entities upon successful authentication. This service helps to ensure that data integration and sensitive information access are strictly regulated.

Extension platform 430 houses authorization endpoints 432, which manage authorization tokens necessary for granting acquired entities resource access following successful authentication from source cloud platform 410. Tenant management provider 434 maintains tenant information, validating requests against a whitelist and issuing tokens for authenticated communication between source cloud platform 410 and target multitenant platform 450. This provider may enable external systems (e.g., source cloud platform 410) to authenticate and communicate securely with appropriate tenants.

Tenant management provider 434 may update its records dynamically to reflect tenant changes, ensuring that token issuance and validation are based on current information. It may act as a gatekeeper for tenant identity and authentication, managing tenant whitelists, issuing tokens, and maintaining tenant properties within system infrastructure.

Hosting API 436 is an interface within extension platform 430 that facilitates service access and interaction between source cloud platform 410 and one or more tenants hosted within target multitenant platform 450.

App API client 438 communicates with various APIs, handling data transactions, managing authentication protocols, interpreting error messages, and customizing API requests per tenant. App API client 438 may utilize an existing security model of 450 to facilitate secure operations between source cloud platform 410 and target multitenant platform 450. Furthermore, App API client 438 may enable various self-service operations and/or integrate artificial intelligence to deliver intelligent data integration services.

Finally, traffic management service 440 directs flow of requests and data through extension platform 430, functioning as a reverse proxy that validates authentication and routes requests to appropriate downstream services and/or tenants. It may facilitate efficient data flow, maintaining data integrity, and preventing unauthorized access, thus upholding security and organization of a data integration framework of target multitenant platform 450.

FIG. 4C presents a portion of example system 400 that includes target multitenant platform 450. Within this platform, there are various tenants, which are shown as tenant 460 and tenant 470, also referred to herein as “tenant A” and “tenant B,” respectively.

Each of the tenants includes three primary components. The first is tenant mapping 462 and tenant mapping 472, which serves as a mechanism and/or operation to map each respective tenant to an acquisition entity (e.g., company) within source cloud platform 410. The next component is “configure credentials 464” and “configure credentials 474” which each represent a task for management and setup of authentication credentials for each respective tenant. The third component is API client 466 and API client 476, which function as respective interfaces for the tenants to communicate with other modules and services within the platform.

Collectively, these elements and connections within the target multitenant platform 450 facilitate the management of data, credentials, and API interactions for multiple tenants. Target multitenant platform 450 is designed to operate a multitenant environment, where each tenant maintains its unique set of data mappings, credentials, and client interfaces, yet is part of a cohesive system that ensures interoperability and secure data integration.

Example system 400 facilitates secure data integration and management across multiple components within a cloud-based multitenant environment. Specifically, the system ensures coordinated interactions between source cloud platform 410, authentication service 420, extension platform 430, and target multitenant platform 450.

For company instance 412 and tenant 460, the process begins with operation 480, where target multitenant platform 450 communicates with authentication service 420 to establish a mapping between company instance 412 and tenant 460. Subsequently, in operation 482, authentication service 420 sends tenant information to source cloud platform 410, establishing API endpoint 416. This step ensures that source cloud platform 410 has the necessary details and facilities to authenticate and securely correspond with tenants in target multitenant platform 450.

With the mapping and authentication information in place, company instance 412 initiates operation 484, causing tenant 460 to generate credentials via configure credentials 464. These credentials are then securely transmitted to company instance 412 within source cloud platform 410, thus enabling a trusted connection for subsequent data integration activities.

Moving to operations related to company instance 414 and/or tenant 470, company instance 414, indicated as operation 486, mirrors the process for company instance 412 and/or tenant 460 from above. Upon a request from company instance 414, tenant 470 generates credentials (e.g., configure credentials 474). These credentials are dispatched to company instance 414.

In operation 488, company instance 414 reaches out to the authorization endpoints 432 within extension platform 430. The request includes the credentials (clientID, clientSecret, tenantAlias) and aims to obtain an authorization or bearer token. Authorization endpoints 432 engage tenant management provider 434 to process this request, and upon successful validation, issue the requisite bearer token to company instance 414.

The final steps in this series are encapsulated in operation 490 and operation 492. In these operations, company instance 414 uses the bearer token to initiate a getPOs call to hosting API 436 within extension platform 430. Hosting API 436, in turn, sends a decodeTenant request to app API client 438. The app API client 438 forwards this request to traffic management service 440, which has the responsibility of decoding the tenant data. This decoded information is then routed to the appropriate tenant's resources within target multitenant platform 450.

Together, these operations illustrate a powerful and secure mechanism for integrating and managing data across different entities within a multitenant cloud environment. Example system 400 is designed to handle complex mappings, authentication, and authorization processes, ultimately enabling efficient and secure data synchronization between acquired companies hosted in source cloud platform 410 and target multitenant platform 450. The system's architecture provides a scalable solution that accommodates the dynamic and growing needs of cloud-based enterprise environments.

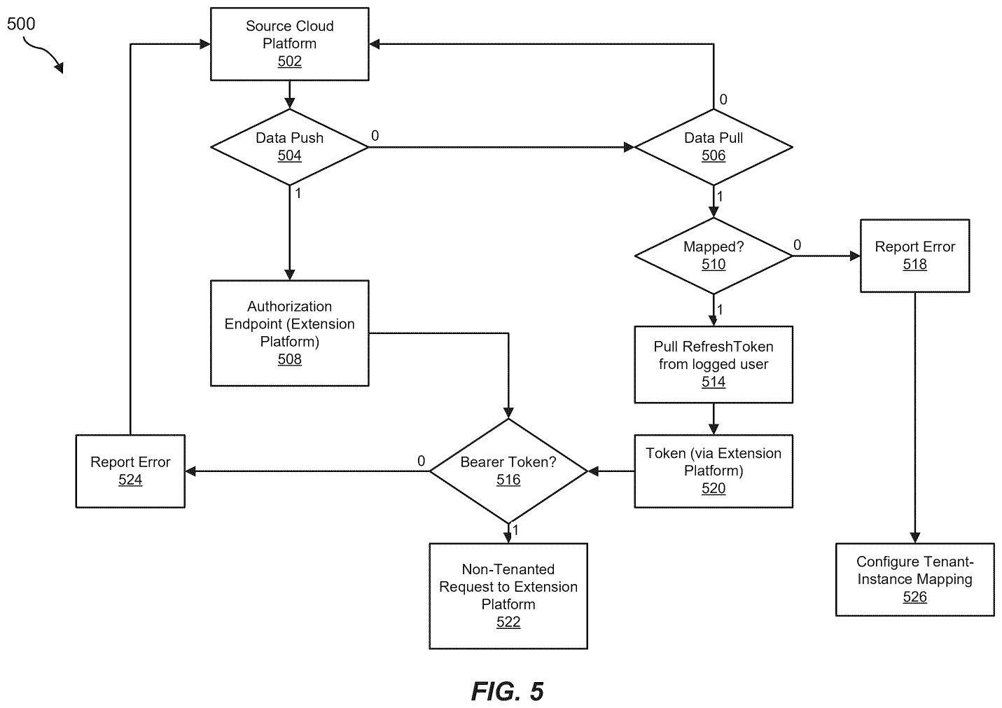

FIG. 5 depicts an operational flow diagram 500 that outlines the sequence of operations for securely integrating acquired data sources within a multitenant environment. This flow diagram visually represents the decision-making process and subsequent actions taken by the system components based on those decisions. Arrows in FIG. 5 illustrate the directional flow between these operations, providing a clear path for the process of data integration within the multitenant environment.

Operation 502 serves as the initiation point for the operational flow, triggering the start of the data integration process within the source cloud platform (e.g., source cloud platform 410 and/or source cloud platform 150).

Decision 504 is a decision point wherein the system determines whether to push data to the extension platform (e.g., extension platform 144, extension platform 430, etc.) or to report an error. If the decision is negative (0), the flow transitions to operation 524, where the system handles the error condition. If positive (1), the process proceeds to Operation 508 to request an authorization token.

Operation 508 involves the system requesting an authorization token from the extension platform's authorization endpoint (e.g., one or more of authorization endpoints 432). Subsequently, the flow moves to decision 516 to check for a valid bearer token. Decision 516 assesses the availability of a valid bearer token. If absent (0), the process redirects to operation 524 to report the error. If present (1), the flow progresses to operation 522, which handles non-tenanted requests to the extension platform.

Decision 506 is a decision point focused on data retrieval. If the system is not ready to pull data (0), it advances to decision 510 to verify tenant-instance mapping. If ready (1), it proceeds directly to operation 514 to obtain a refresh token.

Decision 510 evaluates whether tenant-instance mapping is correctly configured. An unsuccessful outcome (0) leads to operation 518, where the system addresses the mapping error. A successful outcome (1) directs the process to operation 514.

Operation 514 is where the system retrieves a refresh token, which is then used to request a new authorization token. The flow then continues to operation 520. Operation 520 involves requesting a new authorization token from the extension platform using the retrieved refresh token. The flow loops back to decision 516 for token validation.

Operation 522 represents a final step for data requests that do not require tenant context, processed by the extension platform without tenant-specific handling.

Operation 518 and Operation 524 are steps where the system reports errors encountered during the data push or pull operations, mapping, or token validation processes.

Operation 526 signifies the concluding step for configuring the mapping between tenant instances and the source cloud platform, ensuring correct synchronization of each tenant's data with its corresponding source instance.

This operational flow diagram may be helpful in understanding some of the methods of the present disclosure of managing data integration, error handling, and ensuring secure communication between the various components of the multitenant environment.

FIG. 6 is a block diagram illustrating an example system 600 according to some of the disclosed embodiments. As depicted, the example system 600 includes an AI-augmented data integration system 602, a user device 604, and a data integration interface 606.

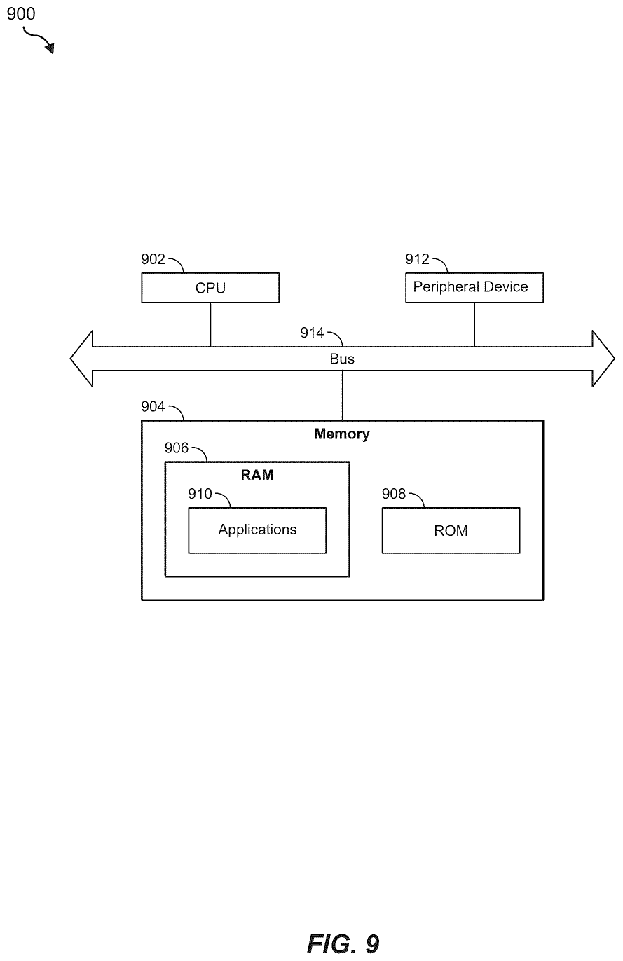

In the illustrated system, user device 604 may include a computing device communicatively coupled to the data integration interface 606. Examples of such devices could include, but are not limited to, a personal computer, a laptop, a tablet, or a mobile phone, user device 604 can be any computing device (such as that depicted in FIG. 9, below) that can interact with the data integration interface and the AI-augmented data integration system.

The AI-augmented data integration system 602 serves as the core of the overall example system 600, providing an advanced platform for the integration of data. As its name suggests, this system leverages artificial intelligence to streamline the process of data integration and to enhance the accuracy and efficiency of the operation.

The AI-augmented data integration system 602 may include two main components: a predictive model 612 and an autonomous agent 610. The predictive model 612 may include a machine learning algorithm that is trained on historical data to learn patterns and correlations. It is designed to predict potential discrepancies in the integrated data based on the input it receives. The predictive model 612 continuously learns and improves its predictive accuracy over time, adapting to new data and scenarios.

The autonomous agent 610 serves as the operational component of the system. It interacts with the predictive model 612, supplying it with current integration data 614 and historic integration data 616, and executing actions based on the predictions generated by the predictive model 612. The autonomous agent 610 handles the actual process of data integration, manipulating data as required, validating data based on the output of the predictive model 612, and even, in some examples, correcting errors when possible.

Current integration data 614 and historic integration data 616 provide data to autonomous agent 610 and predictive model 612. Current integration data 614 may refer to the new data that is to be integrated into the system, such as data transferred from one or more source cloud platform 150 and/or source cloud platform 410. Historic integration data 616, on the other hand, may refer to or include past data that the system has previously processed. This historical data may be used by predictive model 612 as a learning set to improve its future predictions.

By leveraging machine learning and autonomous operations, example system 600 may significantly improve the efficiency and accuracy of data integration tasks. In some examples, an AI-augmented data integration system can be provided to assist users and/or administrators in integrating data into a multitenant platform, such as when an entity may be acquired by another entity that hosts a multitenant platform.

In the depicted system, the AI-augmented data integration system 602 is linked to the data integration interface 606 to receive input and/or feedback from a user during an integration task. In certain implementations, the data integration interface 606 may also receive and present feedback from the AI-augmented data integration system 602, such as confirmation of tasks completed, error messages, or the outcomes of automated integration tasks. Additionally or alternatively, data integration interface 606 may provide feedback to a user in the form of visual indicators, error resolutions, predictive insights. This feedback mechanism may allow users or administrators to verify the success of the data integration task and, if necessary, modify their approach based on the feedback received.

Additionally or alternatively, in some implementations, the AI-augmented data integration system 602 may perform additional or alternative tasks associated with data integration, such as provisioning of computing resources, configuring and/or reconfiguring of the predictive model, and so forth.

In some embodiments, an “Artificial Intelligence (AI) model” or “predictive model” may include a computational construct designed to perform tasks that would typically necessitate human intelligence. These tasks may encompass, but are not limited to, learning from data, identifying patterns, making informed decisions, and forecasting future events. The predictive model is capable of learning from historic integration data to make predictions or decisions related to data integrity, accuracy, and consistency without being explicitly programmed for these specific tasks. Within the scope of the current disclosure, a predictive model, which can be a regression, classification, or ensemble model, is utilized to automate the data integration process. It learns from existing integration data and generates precise predictions for data discrepancies and synchronization issues that may arise during the integration of acquisition entity data into a target multitenant platform.

Moreover, the term “machine learning model” may refer to a particular category of predictive models that enhance their predictive performance over time through data exposure. These models may be adept at recognizing data patterns and then making predictions or decisions based on those patterns. Machine learning models can be specialized for tasks such as regression or classification, and they become more accurate as they process more data. In the context of this disclosure, machine learning models, which include but are not limited to supervised and unsupervised learning approaches, are employed to discern various features relevant to data integration, such as data types, validation rules, and error patterns. They are then able to predict the likelihood of data synchronization errors and suggest appropriate resolutions for the target multitenant platform.

The AI-augmented data integration system 602, as illustrated, encompasses an autonomous agent 610 and a predictive model 612. The autonomous agent 610 interfaces with the predictive model 612, which acts as the brain of the system, processing and generating predictions related to data integration. The predictive model 612 is proficient in analyzing and learning from extensive datasets, including both the current integration data 614 and historic integration data 616. The current integration data 614 provides real-time context for data integration activities, ensuring that the generated predictions are timely and pertinent. The historic integration data 616, including records of past data synchronization attempts and outcomes, aids in shaping the predictive model's forecasts and enhancing its learning process.

In some implementations, the predictive model 612 may be an integral part of the AI-augmented data integration system 602. In other cases, the predictive model 612 may incorporate or interact with third-party predictive services. As previously discussed, the AI-augmented data integration system 602 may receive input data from the user device 604 via the autonomous agent 610. This agent 610 can process the input and generate responses, which are then transmitted back to the user device 604 for display through the data integration interface 606.

The autonomous agent 610 serves as the central processing unit within the AI-augmented data integration system 602. It autonomously conducts tasks, facilitating communication between the user device 604 and the AI-augmented data integration system 602 via the data integration interface 606. Furthermore, the autonomous agent 610 may undertake additional operations such as managing data correction processes and training or refining predictive models based on data feedback (e.g., by generating confidence score(s) indicating a likelihood that output from the predictive models accurately identifies potential data discrepancies in the integrated acquisition entity data).

An “agent” in software engineering can range from simple to complex and is designed to automate tasks or adapt to changing inputs and conditions using AI algorithms. Agents can function independently or collaboratively in systems comprising multiple agents.

In the AI-augmented data integration system 602, the autonomous agent 610 receives input data (queries) from the user device 604, analyzes this data with the help of the predictive model 612, current integration data 614, and historic integration data 616, and generates corresponding predictions. The predictive model 612 empowers the agent to learn from data and develop optimized data integration strategies, while the historic integration data 616 supplies a historical context to guide the decision-making process.

The predictive model 612 refines its understanding of the data by employing sophisticated machine learning techniques to recognize patterns in data integration, interpret the underlying requirements, and provide predictions that are contextually relevant to the data integration process.

Machine learning, as referenced herein, encompasses a suite of algorithms that a predictive model utilizes to identify patterns in data and learn from them. These algorithms enable a model to be trained on a specific dataset, allowing it to make precise predictions or decisions autonomously. In the examples detailed herein, predictive algorithms (e.g., neural networks, decision trees, etc.) are leveraged to optimize the data integration process by learning from past and current integration data, thereby facilitating accurate and efficient data synchronization for the target multitenant platform.

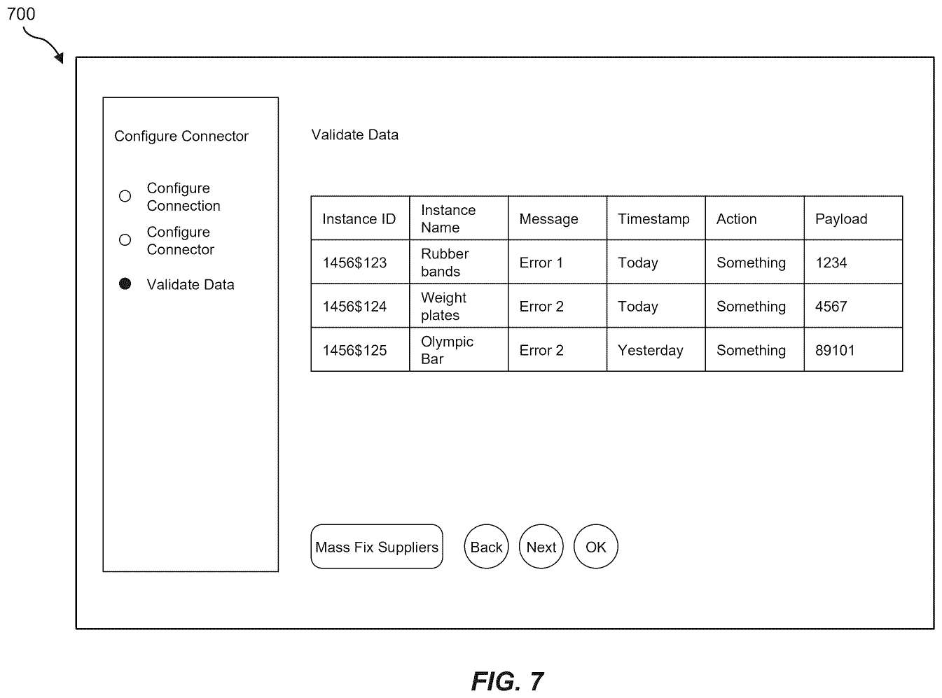

FIG. 7 shows an example of a user interface view 700 for an AI-augmented data integration system. This user interface view is designed to facilitate the validation of integrated acquisition entity data and the configuration of connectors, and may be presented via data integration interface 606 and/or user device 604.

The user interface view 700 is divided into two main sections: a left panel for configuring the connector and a right panel for data validation. The left panel includes a section titled “Configure Connector” with three radio button options: “Configure Connection”, “Configure Connector”, and “Validate Data”. In the depicted instance, the “Validate Data” option is selected, indicating that the user is in the process of validating the integrated data.

The right panel presents a table under the title “Validate Data”. The table contains columns for “Instance ID”, “Instance Name”, “Message”, “Timestamp”, “Action”, and “Payload”. Each row in the table corresponds to a specific instance of the integrated data, providing detailed information about potential discrepancies or issues found during the data integration and/or validation process. For instance, the table displays error messages along with the associated instance ID and name, the time the issue was detected, the action taken, and the payload involved.

These error messages may be generated by AI-augmented data integration system 602. The validation process may involve one or more components of the systems disclosed herein (e.g., AI-augmented data integration system 602) generating an input vector from the acquisition entity data. This input vector may then fed into a predictive model, such as predictive model 612, which may process the vector and produce an output that identifies potential discrepancies within the integrated data. The resulting output may then be displayed in the right panel table, enabling the user to review and address any identified issues.

At the bottom of the user interface view 700, there are four buttons: “Mass Fix Suppliers”, “Back”, “Next”, and “OK”. The “Mass Fix Suppliers” button allows the user to apply a single fix to multiple supplier instances simultaneously, thereby streamlining the process of data correction. The “Back” and “Next” buttons allow the user to navigate between different stages of the data integration process, while the “OK” button is used to confirm changes or fixes applied to the data.

In summary, FIG. 7 presents a user-friendly interface for managing and validating data integration in a multitenant platform, facilitating the process of detecting and addressing data discrepancies.

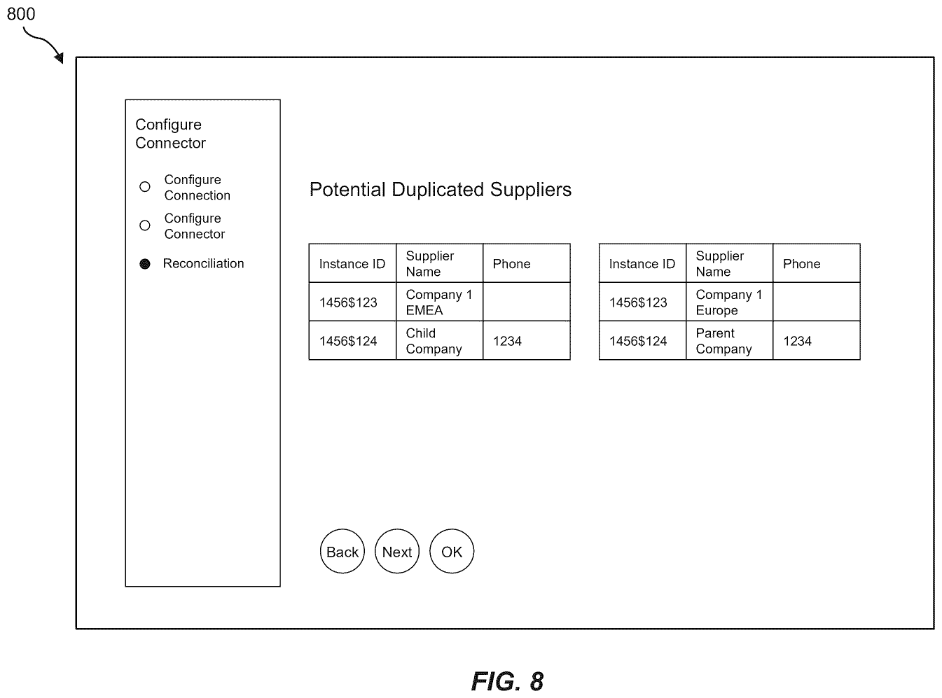

FIG. 8 depicts an example user interface view 800 for an AI-augmented data integration system. This interactive user interface, which, as with user interface view 700, may be presented via data integration interface 606 and/or user device 604, may be specifically designed to assist users in the reconciliation process of potential duplicate data entries that have been integrated into a shared data resource of a multitenant platform.

The user interface view 800 is divided into two main sections: a left panel for navigation and a right panel for the execution of reconciliation tasks.

The left panel features a “Configure Connector” section with radio button options for “Configure Connection”, “Configure Connector”, and “Reconciliation”. In this instance, the “Reconciliation” option is selected, indicating that the user is focused on reconciling potential duplicate data entries.

The right panel presents a title “Potential Duplicated Suppliers” and showcases two tables that display information about suppliers that may have been entered into the system more than once, suggesting potential duplication. Each table lists supplier information, including columns for “Instance ID”, “Supplier Name”, and “Phone”. This arrangement allows users to visually compare entries side-by-side to identify and reconcile potential duplicates.

The user interface of FIG. 8 is designed to interact with an underlying AI-augmented system that aids in detecting duplicates by analyzing integrated data using machine learning models. As noted above, these models can recognize patterns and anomalies that may suggest the presence of duplicate entities. The predictive model may employ techniques such as matching algorithms that compare data fields like supplier names, addresses, and contact information to flag potential duplicates for user review.

Once the AI-augmented system identifies potential duplicates, they are presented within the tables in the right panel. Users can then review these entries and make informed decisions on how to handle them, whether by, for example, merging records, deleting duplicates, or confirming that the entries are indeed unique and should be retained as separate records.

At the bottom of the user interface view 800, there are buttons labeled “Back”, “Next”, and “OK”. These buttons allow users to navigate through the reconciliation process, apply chosen reconciliation actions, and finalize their decisions, respectively.

In summary, FIG. 8 provides an efficient and user-friendly interface for data reconciliation, leveraging AI-driven insights to streamline the process of identifying and resolving potential data duplication within an organization's multitenant platform environment.

FIG. 9 is a block diagram 900 of a computing device according to some embodiments of the disclosure.

As illustrated, the device includes a processor or central processing unit (CPU) such as CPU 902 in communication with a memory 904 via a bus 914. The device also includes one or more input/output (I/O) or peripheral devices 912. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 902 may comprise a general-purpose CPU. The CPU 902 may comprise a single-core or multiple-core CPU. The CPU 902 may comprise a system-on-a-chip (SoC) or a similar embedded system. In some embodiments, a graphics processing unit (GPU) may be used in place of, or in combination with, a CPU 902. Memory 904 may comprise a memory system including a dynamic random-access memory (DRAM), static random-access memory (SRAM), Flash (e.g., NAND Flash), or combinations thereof. In one embodiment, the bus 914 may comprise a Peripheral Component Interconnect Express (PCIe) bus. In some embodiments, the bus 914 may comprise multiple busses instead of a single bus.

Memory 904 illustrates an example of a non-transitory computer storage media for the storage of information such as computer-readable instructions, data structures, program modules, or other data. Memory 904 can store a basic input/output system (BIOS) in read-only memory (ROM), such as ROM 908 for controlling the low-level operation of the device. The memory can also store an operating system in random-access memory (RAM) for controlling the operation of the device.

Applications 910 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 906 by CPU 902. CPU 902 may then read the software or data from RAM 906, process them, and store them in RAM 906 again.

The device may optionally communicate with a base station (not shown) or directly with another computing device. One or more network interfaces in peripheral devices 912 are sometimes referred to as a transceiver, transceiving device, or network interface card (NIC).

An audio interface in peripheral devices 912 produces and receives audio signals such as the sound of a human voice. For example, an audio interface may be coupled to a speaker and microphone (not shown) to enable telecommunication with others or generate an audio acknowledgment for some action. Displays in peripheral devices 912 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 912 may comprise any input device arranged to receive input from a user. An illuminator in peripheral devices 912 may provide a status indication or provide light. The device can also comprise an input/output interface in peripheral devices 912 for communication with external devices, using communication technologies, such as USB, infrared, Bluetooth®, or the like. A haptic interface in peripheral devices 912 provides tactile feedback to a user of the client device.

A GPS receiver in peripheral devices 912 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

As discussed throughout the instant disclosure, the disclosed systems and methods may provide one or more advantages over traditional options for data integration. To illustrate some of the advantages offered by embodiments of the present disclosure for secure integration of acquired data sources within a multitenant platform, consider the following example. In this scenario, XYZ Corporation aims to integrate Company A's data into its multitenant platform with a touchless approach. The goal is to minimize user interaction, aiming for a seamless process that requires the fewest clicks possible. The system is designed to handle the entire integration with minimal input from Company A's administrators, making the integration as efficient as possible.

The integration process begins with the automated creation of API keys and tokens. Using an internal API, the system authenticates Company A's request and securely provisions tokens for Company A's instance in the source cloud platform. These credentials are then stored in a secure credential store, ensuring they are only accessible during runtime operations and never exposed to end-users, thus achieving a goal of humanless key management.

As data is transferred from Company A's systems into the target multitenant platform, the validating module cross-references it against the mutlitenant platform's complex data models. For example, if a phone number does not match the expected format, the system automatically flags the entry and suggests the correct format based on predefined validation requirements. This process not only catches errors but also educates users by transforming technical API errors into clear, actionable language.

During data synchronization, the system proactively scans for potential duplicate entries. For instance, if Company A and an existing tenant have entries with different names but the same tax ID or address, the system flags them as potential duplicates. Users are immediately notified and presented with an intuitive interface that suggests reconciliation actions, such as merging records or confirming distinct entries. This feature ensures data integrity and avoids unnecessary duplication without burdening users with manual checks.

The self-service data correction interface empowers Company A's users and administrators to address and resolve flagged discrepancies with ease. The interface surfaces issues clearly and provides mass fix options, simplifying the process of correcting similar errors across multiple data entries. By enabling administrators to resolve issues directly within the interface, the system significantly reduces the overhead typically associated with data integration.

Post-integration, the system's AI-driven predictive model continues to learn from each interaction. As Company A's data is processed, the machine learning model adapts to new validations and data model changes. This continuous learning capability means that with each subsequent integration, the system becomes more adept at predicting and resolving discrepancies autonomously, thereby reducing the need for manual intervention in the future.

With the integration complete, Company A benefits from a sophisticated system that intelligently manages data synchronization. The touchless integration process, paired with the advanced error handling and self-service capabilities, shows XYZ Corporation's commitment to leveraging technology for efficient, user-friendly data management within its multitenant platform. Moving forward, Company A can expect a streamlined experience with fewer manual processes, as the system evolves to anticipate and address their needs proactively.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

What is claimed is:

1. A method comprising:
authorizing, by a processor, via an extension platform of a target multitenant platform, an acquisition entity to integrate acquisition entity data hosted by a source cloud platform into a target shared data resource of the target multitenant platform;
integrating, by the processor, in response to the authorization, acquisition entity data with the target shared data resource of the target multitenant platform;
validating, by the processor, the integrated acquisition entity data by:
generating an input vector based on the acquisition entity data; and
generating an output indicating potential data discrepancies in the integrated acquisition entity data by inputting the input vector into a predictive model;
responding, by the processor, to the output indicating potential data discrepancies by:
suggesting resolutions for a subset of the potential data discrepancies based on historical data;
generating a user interface displaying the potential data discrepancies and suggested resolutions; and
enabling a user to resolve the potential data discrepancies through the user interface; and
applying at least one of the suggested resolutions across multiple data entries.

2. The method of claim 1, further comprising:
receiving, by the processor, a request to map a target tenant of the target multitenant platform to an acquisition instance of the source cloud platform corresponding to the acquisition entity; and
mapping, by the processor, via an internal authentication service of the target multitenant platform, the acquisition instance of the source cloud platform to the target tenant in the target multitenant platform.

3. The method of claim 2, further comprising:
configuring, by the processor via the internal authentication service of the target multitenant platform, a tenant mapping information endpoint within the source cloud platform that, when queried with information associated with the acquisition entity, returns identifying information of the target tenant;
receiving, by the processor via the tenant mapping information endpoint, a query comprising information associated with the acquisition entity; and
returning, by the processor via the tenant mapping information endpoint in response to the query, identifying information of the target tenant.

4. The method of claim 1, further comprising authorizing, by the processor via the extension platform of the target multitenant platform, the source cloud platform to transfer data associated with the acquisition entity and hosted by the source cloud platform by:
receiving a request to send, via the source cloud platform, a credential to the acquisition entity; and
sending, to the acquisition entity via the source cloud platform, the credential.

5. The method of claim 4, further comprising authorizing, by the processor via the extension platform of the target multitenant platform, the source cloud platform to transfer data associated with the acquisition entity and hosted by the source cloud platform by:
receiving, via an authorization service of the extension platform of the target multitenant platform, a request from the acquisition entity for an authorization token, the request comprising the credential;
generating, via the authorization service of the extension platform of the target multitenant platform, an authorization token; and
sending, via the source cloud platform, the authorization token to the acquisition entity.

6. The method of claim 5, further comprising:
receiving, by the processor via an application programming interface (API) endpoint hosted by the extension platform of the target multitenant platform, a data integration request comprising the authorization token;
authenticating, by the processor, the authorization token; and
authorizing, by the processor, the acquisition entity to integrate acquisition entity data hosted by the source cloud platform into the target shared data resource of the target multitenant platform in response to authenticating the authorization token.

7. The method of claim 1, further comprising allocating, by the processor, resources within the target multitenant platform to a target tenant in response to a tenant setup request received from the acquisition entity via the source cloud platform.

8. The method of claim 1, further comprising integrating, by the processor, acquisition entity data with the target shared data resource of the target multitenant platform by transferring encrypted data associated with the acquisition entity to the multitenant data resource of the target multitenant platform.

9. The method of claim 8, further comprising decrypting, by the processor, the encrypted data associated with the acquisition entity via a decryption service of the extension platform of the target multitenant platform.

10. The method of claim 1, further comprising providing, by the processor, a self-service task to the acquisition entity to enable integration of the acquisition entity data with the target shared data resource.

11. The method of claim 1, further comprising storing, by the processor, generated credentials associated with the acquisition entity in a secure credential store accessible only during runtime and isolated from users, the generated credentials used for authentication during the integration of acquisition entity data with the target shared data resource of the target multitenant platform.

12. The method of claim 1, further comprising training, by the processor, the predictive model using historical data and known data discrepancies to improve accuracy in detecting potential data discrepancies in future integrated data.

13. The method of claim 12, further comprising utilizing, by the processor, a feedback mechanism, where corrected data discrepancies are used as new training data for the predictive model.

14. The method of claim 12, further comprising validating, by the processor, the output of the predictive model against known outcomes to improve a performance metric of the predictive model over time.

15. The method of claim 12, further comprising employing a plurality of different machine learning algorithms in the predictive model to optimize detection of potential data discrepancies.

16. A method comprising:
collecting, by a processor, a data set associated with a set of integrated acquisition entities of a target multitenant platform, the data set comprising, for each integrated acquisition entity included in the set of integrated acquisition entities, integrated acquisition entity data associated with the acquisition entity;
training, based on the data set, a predictive model to generate, based on an input vector, an output indicating potential data discrepancies in the integrated acquisition entity data, the training comprising:
cleaning the data set;
transforming the data set into a format analyzable by the predictive model;
analyzing the data set in accordance with a training methodology of the predictive model; and
configuring the predictive model by adjusting one or more parameters included in the predictive model to improve accuracy in detecting potential data discrepancies in future integrated data.

17. The method of claim 16, further comprising collecting, by the processor, the data set from a shared data resource of the target multitenant platform.

18. The method of claim 16, further comprising tuning, by the processor, the predictive model by adjusting a hyperparameter of the predictive model, the hyperparameter selected from a set of hyperparameters comprising:
a maximum depth of layers of the predictive model; and
a maximum number of features of the predictive model.

19. A method comprising:
receiving, by a processor, a query comprising data that describes integrated acquisition data of an acquisition entity;
querying, by the processor, using the query, a plurality of predictive models to generate a plurality of outputs, each predictive model in the plurality of predictive models trained using a different data set associated with integrated acquisition entities of a target multitenant platform;
aggregating, by the processor, the plurality of outputs into an aggregated output; and
determining, by the processor, based on the aggregated output, potential data discrepancies in the integrated acquisition entity data by consolidating the plurality of outputs into a consolidated query result.

20. The method of claim 19, further comprising generating, by the processor, a confidence score for the aggregated output, the confidence score indicating a likelihood that the aggregated output accurately identifies potential data discrepancies in the integrated acquisition entity data.
